(19) United States
(12) Patent Application Publication
(10) Pub. No.: US 2025/0284884 A1
(43) Pub. Date: Sep. 11, 2025

(54) CONTEXT-AWARE MULTI-MODEL AGGREGATORS

(71) Applicant: International Business Machines Corporation, Armonk, NY (US)

(72) Inventors: Adam Lee Griffin, Cohasset, MA (US); Balaji Muthusamy Pandurangan, Amsterdam (NL); Vivek Soni, Pune (IN)

(21) Appl. No.: 18/596,173

(22) Filed: Mar. 5, 2024

(51) Int. Cl. G06F 40/20; G06F 16/242

(52) U.S. Cl. CPC G06F 40/20; G06F 16/244

(57) ABSTRACT

A computer-implemented method, according to one approach, includes: receiving, at a context-aware multi-model aggregator, a user query from an endpoint device. The user query is evaluated, and models and/or combinations of models are selected to evaluate the user query based at least in part on the evaluation of the user query. An adaptive reasoner of the context-aware multi-model aggregator is used to select an output to the user query based at least in part on results of the selected models and/or combinations of models. The output is transmitted to the endpoint device, and reinforcement learning is performed based at least in part on feedback received from the endpoint device.

### BACKGROUND

The present invention relates to processing user queries, and more specifically, this invention relates to using a multi-model aggregators to process user queries.

AI based models have emerged in recent years, providing users the ability to submit various requests (e.g., prompts) that are evaluated and answered in real-time. For example, AI chatbots have been developed over time to simulate human conversation. It should be noted that “AI chatbot” is an umbrella term which refers to different types of AI-based interfaces that can provide responses to various prompts or queries that are entered. In other words, AI chatbots may include any AI based software applications that aim to mimic human conversation using text or voice interactions to respond to prompts that are submitted by users. These interactions typically extend across an online connection and involve AI systems that are capable of maintaining a conversation with the users.

AI based models have traditionally been limited to single source models. Conventional products have thereby traditionally only been able to satisfy relatively simple prompts. However, as user submissions become more complex over time, these conventional products have been forced to process the more complex prompts for longer amounts of time, thereby increasing resource consumption in an attempt to remain relevant. While this maintains operation at the expense of efficiency, single source models have finite capabilities.

### SUMMARY

A computer-implemented method (CIM), according to one approach, includes: receiving, at a context-aware multi-model aggregator, a user query from an endpoint device. The user query is evaluated, and models and/or combinations of models are selected to evaluate the user query based at least in part on the evaluation of the user query. An adaptive reasoner of the context-aware multi-model aggregator is used to select an output to the user query based at least in part on results of the selected models and/or combinations of models. The output is transmitted to the endpoint device, and reinforcement learning is performed based at least in part on feedback received from the endpoint device.

A computer program product (CPP), according to another approach, includes: a set of one or more computer-readable storage media, and program instructions. The program instructions are collectively stored in the set of one or more storage media, and are for causing a processor set to perform the foregoing CIM.

A computer system (CS), according to yet another approach, includes: a processor set and a set of one or more computer-readable storage media. The CS also includes program instructions that are collectively stored in the set of one or more storage media, and which are for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a partial representational view of a context-aware multi-model aggregator, in accordance with one approach.

FIG. 2C is a representational view of a repository of available models, in accordance with one approach.

FIG. 3A is a flowchart of a method, in accordance with one approach.

FIG. 3B is a flowchart of sub-operations for one of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for selecting a unique combination of AI based models that is best suited to respond to a user query based on an understanding of the context of the query. This selection is made at least in part by context-aware multi-model aggregators that are capable of identifying which AI based models should be combined (and in what specific order) to achieve a desired outcome in a most efficient manner. This is accomplished at least in part by understanding how the models will provide information (e.g., signals) to each other, and whether each of the models are configured to best respond to the query entered by a user. In other words, approaches herein understand how the pre-processing output of one AI based model can be used by another, as well as understanding how each model provides the output that it does, e.g., as will be described in further detail below.

In one general approach, a CIM includes: receiving, at a context-aware multi-model aggregator, a user query from an endpoint device. The user query is evaluated, and models and/or combinations of models are selected to evaluate the user query based at least in part on the evaluation of the user query. An adaptive reasoner of the context-aware multi-model aggregator is used to select an output to the user query based at least in part on results of the selected models and/or combinations of models. The output is transmitted to the endpoint device, and reinforcement learning is performed based at least in part on feedback received from the endpoint device.

In another general approach, a CPP includes: a set of one or more computer-readable storage media, and program instructions. The program instructions are collectively stored in the set of one or more storage media, and are for causing a processor set to perform the foregoing CIM.

In yet another general approach, a CS includes: a processor set and a set of one or more computer-readable storage media. The CS also includes program instructions that are collectively stored in the set of one or more storage media, and which are for causing the processor set to perform the foregoing CIM.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved user query response code at block 150 for selecting a unique combination of AI based models that is best suited to respond to a user query based on an understanding of the context of the query, e.g., as will be described in further detail below. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

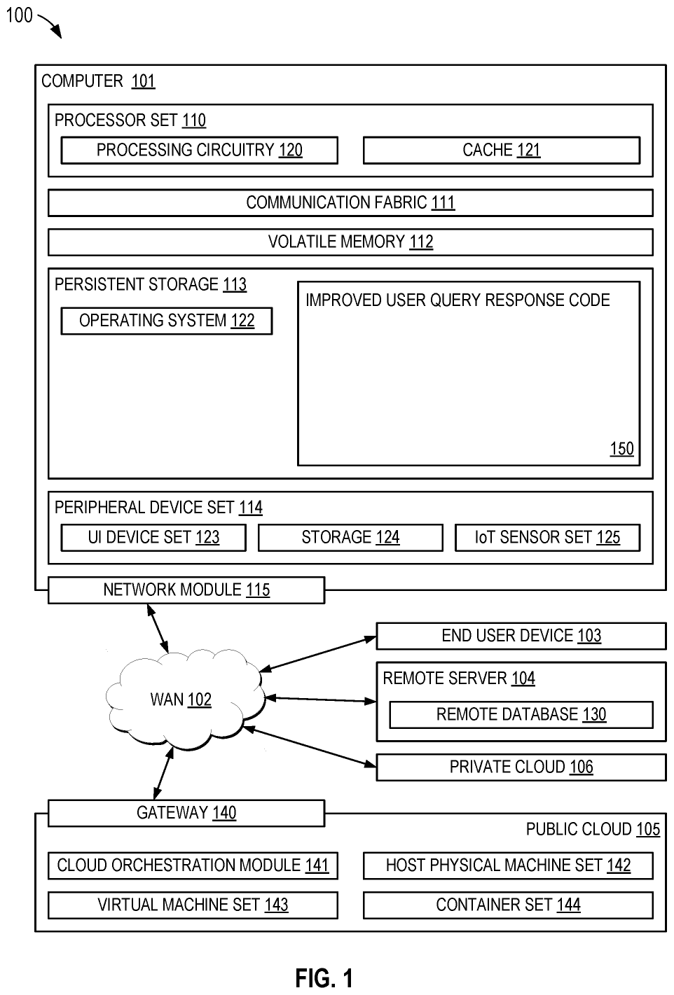

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, AI based models have emerged in recent years, providing users the ability to submit various requests (e.g., prompts) that are evaluated and answered in real-time. For example, AI chatbots have been developed over time to simulate human conversation. It should be noted that “AI chatbot” is an umbrella term which refers to different types of AI-based interfaces that can provide responses to various prompts or queries that are entered. In other words, AI chatbots may include any AI based software applications that aim to mimic human conversation using text or voice interactions to respond to prompts that are submitted by users. These interactions typically extend across an online connection and involve AI systems that are capable of maintaining a conversation with the users.

AI based models have traditionally been limited to single source models. Conventional products have thereby traditionally only been able to satisfy relatively simple prompts. However, as user submissions become more complex over time, these conventional products have been forced to process the more complex prompts for longer amounts of time, thereby increasing resource consumption in an attempt to remain relevant. While this maintains operation at the expense of efficiency, single source models have finite capabilities.

In sharp contrast to these shortcomings, approaches herein generate and utilize multi-modal aggregator models that are configured to combine multiple types (e.g., “modes”) of data by combining the outputs of several different AI models. This allows for the multi-modal aggregator models to combine traditional machine learning models, deep-learning models, and foundational models, and ultimately create more accurate determinations, draw more insightful conclusions, and make more precise predictions about real-world problems, e.g., at least in comparison to single source models. Multi-modal aggregator models are thereby able to process more complex prompts.

Depending on the approach, multi-modal aggregator models may combine the outputs of any type of model that mimics cognitive functions associated with human minds, including all aspects of learning, reasoning, perceiving, and problem solving. Thus, approaches herein are able to combine the capabilities of multiple AI based models to achieve an output with tunable levels of detail. According to a simplified example, which is in no way intended to be limiting, the capabilities of a generative AI model may be combined with the capabilities of one or more LLMs to generate unique responses to queries entered verbally by extracting contextual information from the spoken words. It follows that “AI based models” as used herein may include any type of machine learning systems that have been trained on historical data to uncover patterns, deep learning models having layers of neural networks working together to process information, natural language processing models, foundation models configured to generate sequences of related data elements, etc., or any other type of AI related system and/or combinations thereof.

Again, approaches herein desirably utilize context-aware multi-model aggregators to identify which AI based models should be combined (and in what specific order) to achieve a desired outcome in a most effective manner. This is accomplished at least in part by understanding how the models will provide information (e.g., signals) to each other, and whether each of the models are configured to best respond to the query entered by a user. In other words, approaches herein understand how the pre-processing output of one AI based model can be used by another, as well as understanding how each model provides the output that it does. For instance, some approaches are able to determine the trustworthiness of the results output by each model in a combined AI model, as well as the output of the combined AI model itself.

According to some approaches, one or more protocols may be developed that enable context-aware multi-model aggregators to choose one or more AI workloads from public and/or private hubs to facilitate and manage complex use cases. Moreover, this is achieved while also remaining aligned with any desired set of standards, e.g., such as any enterprise grade data and/or privacy standards. Furthermore, multi-modal aggregator models may be trained using different types of data in tandem to help establish content and better interpret context. Determining how each type of data is evaluated and how the data impacts the outcome of the model provides insight that ultimately increases applicability of the model. This is achieved, at least in part, based on adaptive reasoning and reinforcement learning, e.g., as will be described in further detail below.

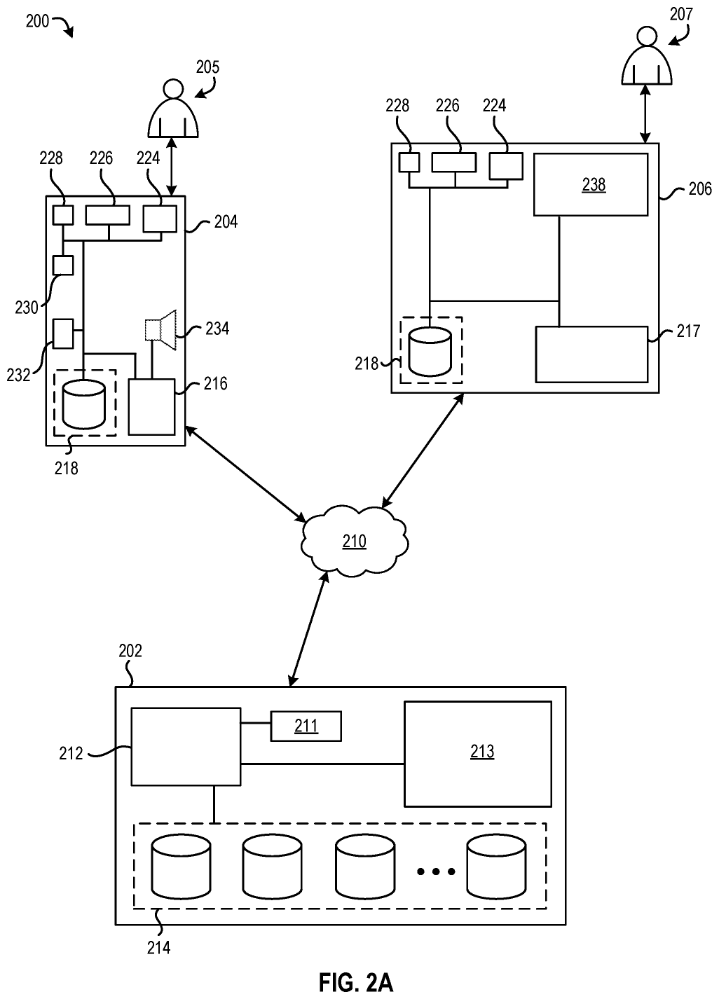

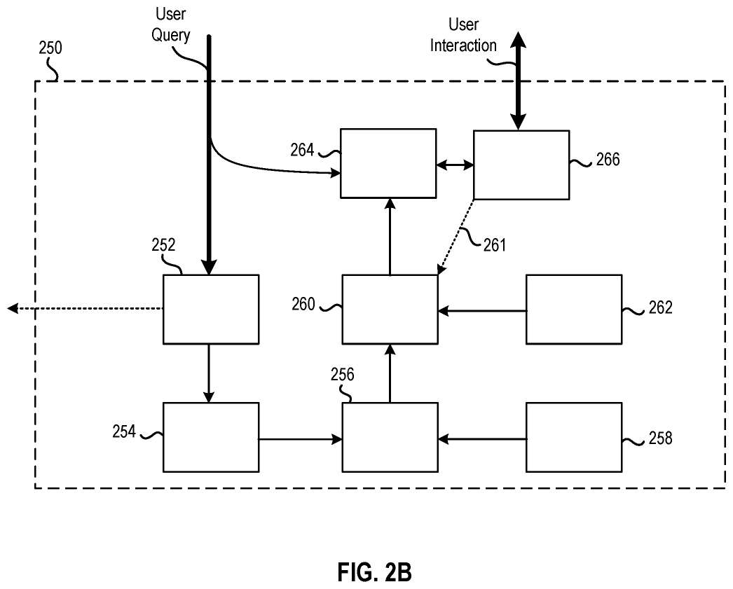

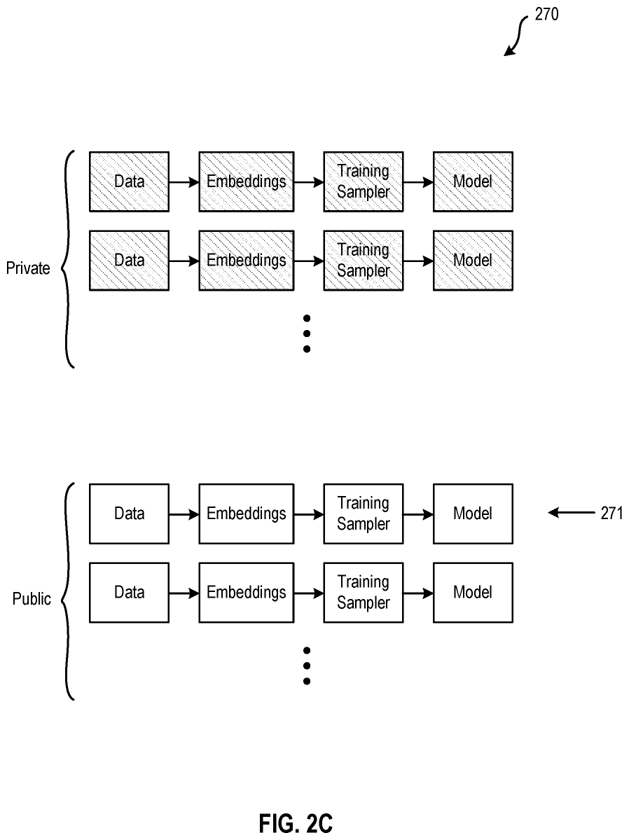

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206 accessible to the user 205 and administrator 207, respectively. The user device 204 and edge node 206 may thereby be considered “endpoint devices,” each of which are connected to the central server 202. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data,” “datasets,” and “information” herein are in no way intended to be limiting either, and may include any desired type of details, e.g., depending on the type of operating system implemented on the user device 204, edge node 206, and/or central server 202. In some approaches, datasets of textual entries (e.g., strings of alphanumeric characters) that are generated at the edge node 206 may be kept at the edge node 206 to ensure data security and retention. For example, datasets having sensitive information (e.g., personal data, financial data, intellectual property, etc.) may intentionally be retained at an edge server where the datasets were formed. However, other information deemed as not being sensitive may be sent to the central server 202 from user device 204 and/or edge node 206 for processing using one or more machine learning models.

With continued reference to FIG. 2A, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 may include one or more context-aware multi-model aggregators that are able to (along with processor 212) satisfy a wide range of queries that may be received, e.g., from endpoint devices 204, 206 or any other devices that are connected to network 210. With respect to the present description, a “context-aware multi-model aggregator” refers to one or more models that have been trained such that they are configured to receive a user query, extract contextual information from the query, select various AI based models and/or combinations of various AI based models that may be used to solve the user query based at least in part on the extracted contextual information, and ultimately select a response to the user query (e.g., an “output”) based on how the selected models and/or combinations of models respond to the user query. It follows that AI module 213 and/or processor 212 may be used to perform one or more of the operations in method 300 below to answer a user query in a most efficient and accurate way possible, e.g., as will be described in further detail below.

With continued reference to FIG. 2A, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Queries may be submitted by user 205 using user device 204 and central server 202. For instance, queries that involve non-sensitive topics and/or data may be received from user 205 through user device 204 for evaluation using AI module 213 at central server 202. The queries may be received as a result of the user 205 using one or more applications, software programs, temporary communication connections, etc. running on the user device 204. For example, the user 205 may use user device 204 to enter (e.g., type) and upload a query to be evaluated and solved using processor 212 and/or AI module 213 of central server 202. As a result, a context-aware multi-model aggregator at the central server 202 may be used to efficiently evaluate and process even complex queries, e.g., as will be described in further detail below.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238.

As described above with respect to AI module 213, the AI module 238 may include one or more context-aware multi-model aggregators that are able to (along with controller 217) satisfy a wide range of queries that may be received, e.g., from administrator 207. As noted above, a context-aware multi-model aggregator is preferably configured to receive a user query, extract contextual information from the query, select various AI based models and/or combinations of various AI based models that may be used to solve the user query based at least in part on the extracted contextual information, and ultimately select a response to the user query (e.g., an “output”) based on how the selected models and/or combinations of models respond to the user query. It follows that AI module 238 and/or controller 217 may be used to perform one or more of the operations in method 300 below to answer user queries in a most efficient and accurate way possible, e.g., as will be described in further detail below.

Looking now to FIG. 2B, a representational diagram of a context-aware multi-model aggregator 250 which may be used to satisfy incoming user queries is illustrated in accordance with one approach which is in no way intended to be limiting. It follows that any details of the multi-model aggregator 250 described herein may be included in and implemented by AI module 213 and/or 238 of FIG. 2A to satisfy received user queries, e.g., as would be appreciated by one skilled in the art after reading the present description.

As shown, a user query is received by the multi-model aggregator 250 and directed to a sensor 252 that is configured to scan queries as they are received for malicious activity. The sensor 252 is thereby configured to inspect the user query and determine whether the query includes any malicious activity. Depending on the approach, “malicious activity” may include queries that implement injection techniques attempting to retrieve confidential data, hallucinogenic queries tailored to abuse model functionality, etc., and other malformed requests. In situations where the received user query is identified by the sensor 252 as including malicious activity, the query is ignored (e.g., failed) and no answer is provided. In some approaches, a warning and/or error message may be output to the user the provided the rejected query, to an administrator to alert them of malformed requests, to a storage location to record the rejected request for future evaluation, etc., as indicated by the dashed line.

A user query determined as not including any malicious activity is advanced from sensor 252 to context analyzer 254. In response to receiving the user query, the context analyzer 254 extracts information from the query to gain an understanding of what the user is actually requesting. The context analyzer 254 may develop this understanding by first converting the user query into a desired format before developing a contextual understanding of the user query. According to an example, which is in no way intended to be limiting, an audio signal corresponding to a verbal user query may be converted into text before being evaluated with one or more large language models.

To develop an understanding of what the user query is actually requesting, the context analyzer 254 may extract a subject, verbs, modifiers, objects, etc., or any other components of the query that provide insight as to what is being requested. At least some of these components may be extracted as a result of a textual representation of the user query being processed (e.g., evaluated) using one or more large language models. In some approaches, the context analyzer 254 refers to past user queries that have been received and how they were responded to, along with whether the provided responses were sufficiently accurate responses to the respective original queries. In some approaches, the context analyzer 254 implements AI based models that are trained (e.g., retrained) to evaluate user queries and develop a contextual understanding of each.

The insight achieved by the context analyzer 254 is passed to a service selector 256. The service selector 256 works in combination with the service and context mapper 258 (or “service mapper”) to identify a number of models and/or combinations of models that may be used to evaluate the user query. In other words, individual models may be suggested for processing the user query, while different combinations of two or more models may also be suggested for processing the user query. Suggesting a number of individual models and/or combinations of models that may be used to process the user query provides a range of possible solutions that may be selected from to ultimately produce an accurate (e.g., correct) response. The service selector 256 and mapper 258 may thereby reference the developed understanding of what the user query is actually requesting while selecting one or more models that are able to evaluate the user query and provide a legitimate response. Selecting individual models and/or combinations of models that comply with this learned contextual information improves how closely outputs of the models map to the original query, and how effective the context-aware multi-model aggregator is as a whole.

The mapper 258 may store a number of individual models and combinations of models, as well as information associated with how each model or combination of models performed in response to a number of different queries. It follows that the mapper 258 may be updated over time based on performance, adding additional models and combinations of models along with how they respond to various queries. This information provides valuable context while evaluating newly received user queries, e.g., as would be appreciated by one skilled in the art after reading the present description. The mapper 258 may additionally store pre-defined combinations of models that are based at least in part on receiving specific inputs. In other words, one or more predefined individual models and/or specific combinations of models may be stored in the mapper 258 as being correlated with specific user inputs. In response to receiving an input that is correlated with specific models and/or combination of models, those models and/or combinations of models may be determined from the pre-configuration and used to evaluate the user input, e.g., rather than entertaining new suggestions made by the service mapper. It follows that in some approaches, the service mapper is configured to suggest certain models and/or combinations of models, along with providing users the option to pre-define certain workflow using predefined correlations.

With continued reference to FIG. 2B, the selected individual models and/or combinations of models are passed from the service selector 256 to the adaptive reasoner 260, along with the user query. There, the adaptive reasoner 260 evaluates the query a number of different times, using each of the selected individual models and/or combinations of models to generate a response (e.g., output). The adaptive reasoner 260 thereby effectively tests how each suggested model or combination of models responds to the received user query, and determines whether each response is satisfactory. Determining whether a response is “satisfactory” may involve comparing the response to past user feedback to determine whether it has previously received positive feedback in response to similar user queries in some approaches.

In some approaches, responses produced by the selected models and/or combinations of models may be compared against one or more standards (e.g., guidelines). For instance, the detector 262 may be used in some approaches to inspect the selected models and/or combinations of models based on predetermined data and/or privacy standards. In other words, the detector 262 may apply data and/or privacy standards to determine whether each of the selected models and combinations of models is even permitted. The data and privacy standards that are applied may be selected based at least in part on the types of models that have been selected, the type of user query that was initially received, preset user configurations, in a dynamic fashion based on performance metrics as they are received in real time, etc.

The adaptive reasoner 260 thereby works with the detector 262 to select a response (e.g., output) to the user query from the selected models and/or combinations of models used to evaluate the user query. In other words, the adaptive reasoner 260 selects an output produced by one of the selected individual models or combinations of models, and designates the selected output as the response to the received user query. The adaptive reasoner 260 thereby sends the selected response as well as the model or combination of models that produced the selected response to an implementation module 264. In some approaches, module 264 may be used to apply (e.g., run) model or combination of models that produced the selected response, e.g., such that any subsequent user queries may be processed using the same model(s).

Moreover, the application programming interface (API) 266 allows the context-aware multi-model aggregator 250 to interact with a user that issued the query being answered. For example, the API 266 may be used to visually display a response to the user query. The API 266 may also allow the user to provide feedback, e.g., such as whether the provided response was a satisfactory response. Depending on the approach, the API 266 may provide logical buttons, text entry fields, document upload capabilities, audio and/or visual information entry fields, etc., that allow the user to interact with the context-aware multi-model aggregator 250. For example, the API 266 may allow the user to indicate whether the provided query response is a desirable outcome to the initial query, or if it is undesirable. This feedback can further be used to perform reinforcement learning using (e.g., by) the adaptive reasoner 260, e.g., as indicated by dashed line 261. Negative feedback regarding a user query response may be used to suppress the model(s) that produced the rejected query response, at least in similar situations. However, positive feedback may promote the model(s) that produced the accepted query response in response to similar queries. The multi-model aggregator 250 is thereby able to gain contextual information over time and provide more reliable responses to user queries.

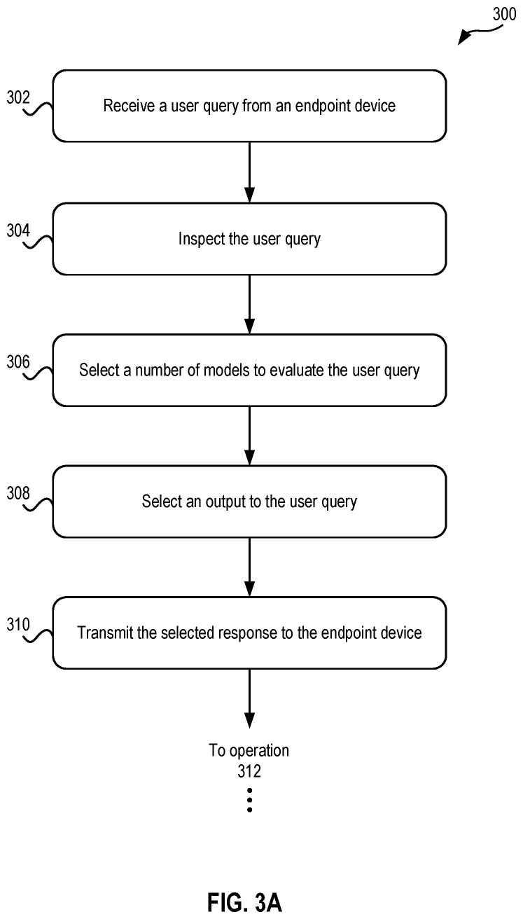

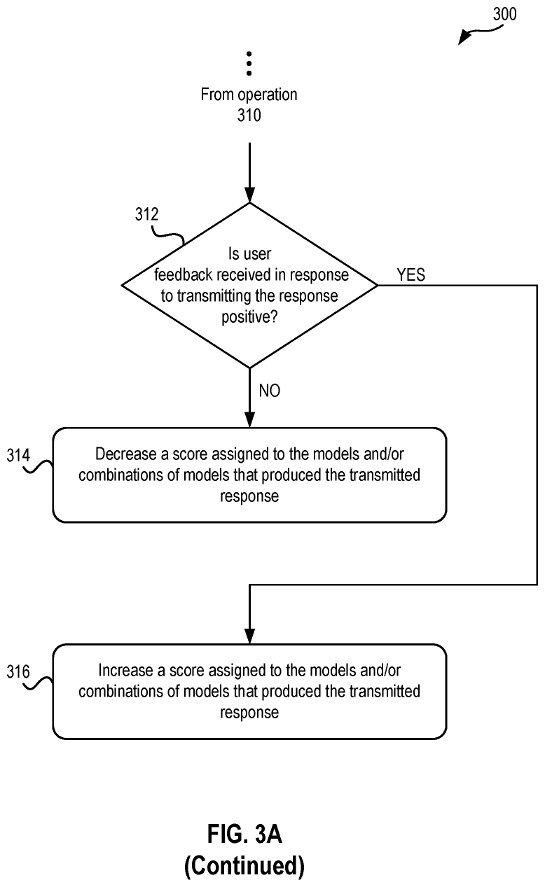

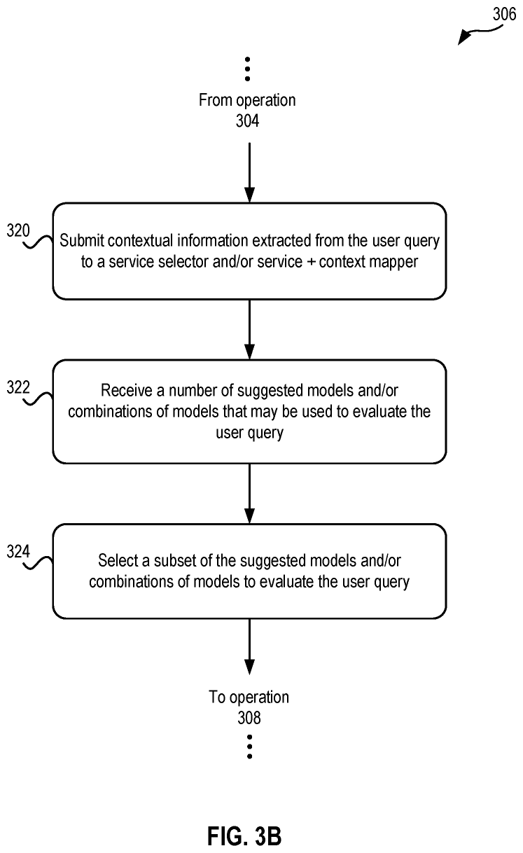

Looking now to FIG. 3A, a flowchart of a computer-implemented-method 300 for selecting a unique combination of AI based models that is best suited to respond to a user query based on an understanding of the context of the query is illustrated in accordance with one approach. In other words, method 300 includes maintaining and applying a context-aware multi-model aggregator to received user queries. The method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in some approaches one or more of the operations in method 300 may be performed by a context-aware multi-model aggregator (e.g., see aggregator 250 of FIG. 2B), which may be implemented in an AI based module (e.g., see AI modules 213, 238 of FIG. 2A). However, the method 300 may be partially or entirely performed by a controller, a processor, a computer, etc., or some other device having one or more processors therein. Moreover, the terms computer, processor and controller may be used interchangeably with regards to any of the approaches herein, such components being considered equivalents in the many various permutations of the present invention.

For those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes receiving a user query from an endpoint device. As mentioned above, an endpoint device may include a user device (e.g., laptop, mobile phone, tablet, etc.), an edge node, a dedicated user interface, etc. Accordingly, the user query may be received from any number of locations. The type and/or complexity of user query that is received may also vary depending on the situation. For example, responding to some user queries may involve providing a more detailed and/or specific type of response in comparison to less complex and/or different types of queries.

Moreover, the same user queries may be received more than once over time. Each time a specific user query is received, the answer provided, and any resulting user feedback, are preferably stored such that they may be referred to a next time the same user query is received. This desirably improves response times and reduce compute overhead by utilizing past performance.

From operation 302, method 300 advances to operation 304. There, operation 304 includes inspecting (e.g., evaluating) the user query. The user query is preferably evaluated using a context analyzer of the context-aware multi-model aggregator (e.g., see context analyzer 254 of FIG. 2B). As previously mentioned, the context analyzer is desirably able to extract information from the query to gain an understanding of what the user is actually requesting. Thus, performing operation 304 develops an understanding of the user query. To develop an understanding of what the user query is actually requesting, operation 304 may include extracting a subject, verbs, modifiers, objects, etc., or any other components of the query that provide insight as to what is being requested.

At least some of these components may be extracted as a result of a textual representation of the user query being processed (e.g., evaluated) using one or more large language models. In some approaches, performing operation 304 includes referring to past user queries that have been received and how they were responded to, along with whether the provided responses were sufficiently accurate responses to the respective original queries. In some approaches, AI based models that have been trained (e.g., retrained) to evaluate user queries and develop a contextual understanding of each, may be used.

Proceeding now from operation 304 to operation 306, method 300 includes selecting a number of models to evaluate the user query. In other words, operation 306 includes selecting numerous instances of: (i) individual models and/or (ii) specific combinations of models based at least in part on the evaluation of the user query (e.g., performed by a context analyzer). Performing operation 306 may thereby produce a number of individual models, a number of unique combinations of models, or combinations thereof (also referred to herein as “models and/or combinations of models”), each of which may be used to process the received user query.

It should also be noted that “model” or “models” as used herein is intended to refer to any AI based models and/or workloads that are capable of processing an input and generating a correlated output, or serving as a base structure that may be trained to produce a desired output, e.g., as would be appreciated by one skilled in the art after reading the present description. The models may thereby include any desired artificial intelligence (AI) based models, e.g., such as machine learning models, generative AI models, deep learning models (e.g., having layers of neural networks working together to process information), natural language processing models, large language models, foundation models, etc. Thus, in some approaches, combinations of generative AI models and large language models are selected to process a received user query.

Looking briefly to FIG. 2C, a repository 270 of available Private and Public models are illustrated in accordance with one approach. As shown, each model (e.g., model 271) includes data, embeddings, a training sampler, and the resulting model. Moreover, each of the models in the repository 270 may be merged with each other to form unique combinations. In other words, two or more models may be combined such that the output of one model serves as an input for the next model, thereby processing the user query in a specific order of operations. In some approaches, the repository 270 may be stored in a service and context mapper (e.g., see mapper 258 in FIG. 2B).

While Public models typically include information (e.g., data, embeddings, training samplers, models) that may be shared publicly, private models may include sensitive information. It follows that the Public and Private models may be best suited for different use cases. In some approaches, it may be desirable that only Public models and combinations of Public models are used to process the user query, e.g., to avoid exposing any private information. In other approaches, it may be desirable that only Private models and combinations of Private models are used to process a user query that is specific to a private environment. In still other approaches, it may be desirable that a combination of Private and Public models and combinations of Private and Public models are used to process some user queries.

In order to avoid inadvertently exposing sensitive information (e.g., medical records, financial information, security details, etc.), a detector may inspect models that are selected based on predetermined data and/or privacy standards. The data and privacy standards that are applied may be selected based at least in part on the types of models that have already been selected, the type of user query that was initially received, preset user configurations, in a dynamic fashion based on performance metrics as they are received in real time, etc.

Returning now to FIG. 3A, the insight achieved by performing the evaluation in operation 304 is utilized while selecting the models in operation 306. In some approaches, a service selector works in combination with a service and context mapper to identify a number of models and/or combinations of models that may be used to evaluate the received user query. This provides a range of possible solutions that may be selected from to ultimately produce an accurate (e.g., correct) response to the user query. The service selector and mapper may thereby reference the developed understanding of what the user query is actually requesting while selecting one or more models that are able to evaluate the user query and provide a legitimate response. Selecting individual models and/or combinations of models that comply with this learned contextual information improves how closely outputs of the models map to the original query, and how effective the context-aware multi-model aggregator is as a whole.

Referring momentarily now to FIG. 3B, exemplary sub-operations of selecting models and/or combinations of models to evaluate the user query are illustrated in accordance with one approach. It follows that one or more of these sub-operations may be used to perform operation 306 of FIG. 3A. However, it should be noted that the sub-operations of FIG. 3B are illustrated in accordance with one approach which is in no way intended to be limiting.

As shown, sub-operation 320 includes submitting contextual information extracted from the user query to a service selector and/or service+context mapper of the context-aware multi-model aggregator. The contextual information may have been extracted from the user query using a context analyzer in some approaches, e.g., as described above. The service selector and/or service+context mapper may thereby use the contextual information to filter through a repository of available models and combinations of models.

Accordingly, sub-operation 322 includes receiving a number of suggested models and/or combinations of models that may be used to evaluate the user query. In some approaches, the suggestions may actually be received at the service selector from the service+context mapper. In some approaches, the service+context mapper may reference remote model repositories (e.g., over a network). Thus, the suggested models and/or combinations of models may be received by the multi-model aggregator from a remote storage location.

The suggested models and/or combinations of models are preferably evaluated to determine whether each is a viable suggestion. In other words, each suggested model or combination of models is inspected to determine whether it is capable of interpreting the user query and providing a legitimate response. Some of the suggestions may be identified as being configured to provide nonsensical responses to the user query, output responses in an incompatible or undesired format, etc. Thus, sub-operation 324 includes selecting a subset of the suggested models and/or combinations of models to evaluate the user query. Again, the subset is selected based at least in part on the type of outputs produced by each of the respective models.

Returning now to FIG. 3A, method 300 advances from operation 306 to operation 308. There, operation 308 includes selecting an output to the user query. In other words, operation 308 includes evaluating the outputs produced by the models and/or combination of models selected in operation 306, and selecting one of the outputs to serve as the final response to the user query. Operation 308 thereby effectively tests how each suggested model or combination of models responds to the received user query, and determines whether each response is satisfactory. Determining whether a response is “satisfactory” may involve comparing the response to past user feedback to determine whether it has previously received positive feedback in response to similar user queries in some approaches.

In some approaches, operation 308 is performed by an adaptive reasoner of the context-aware multi-model aggregator. The adaptive reasoner may be configured to apply the user query to each model or combination of models and produce an output that is evaluated for accuracy. In some approaches, the adaptive reasoner works with a detector to compare the output of each model or combination of models against one or more standards (e.g., guidelines). For instance, a detector may be used in some approaches to inspect the selected models and/or combinations of models based on predetermined data and/or privacy standards. In other words, the detector may apply data and/or privacy standards to determine whether each of the selected models and combinations of models is even permitted. The data and privacy standards that are applied may be selected based at least in part on the types of models that have been selected, the type of user query that was initially received, preset user configurations, in a dynamic fashion based on performance metrics as they are received in real time, etc.

Operation 308 thereby selects an output produced by one of the selected individual models or combinations of models, and designates the selected output as the response to the received user query. From operation 308, method proceeds to operation 310. There, operation 310 includes transmitting (e.g., outputting) the selected response. The selected response may be transmitted directly to an endpoint device that issued the original user query in some approaches. In other approaches the response may simply be visually illustrated on a display, played from an audio speaker, printed on a piece of paper with a printer, etc., that is accessible to the user that issued the initial query. In still other approaches, the response may be stored at a publicly or privately accessible location (e.g., web address) and a notification may be sent to a user that initially issued the query.

In some approaches, operation 310 involves controlling an API. For example, an API may allow the user to provide feedback, e.g., such as whether the provided response was a satisfactory answer to the initial query. The API may provide logical buttons, text entry fields, document upload capabilities, audio and/or visual information entry fields, etc., that allow the user to interact with the context-aware multi-model aggregator and provide the feedback.

This feedback can further be used to perform reinforcement learning using (e.g., by) the adaptive reasoner. In other words, the adaptive reasoner may be utilized to evaluate the user feedback and implement the reinforcement learning on how the ultimate response to the user query is selected. In some approaches, the reinforcement learning may be implemented by another component in the multi-model aggregator and applied to the adaptive reasoner in response to the learning being applied, e.g., as would be appreciated by one skilled in the art after reading the present description. Accordingly, operation 312 includes determining whether the user feedback received in response to transmitting the response to the user query is positive. Negative feedback regarding a user query response may be used to suppress the model(s) that produced the rejected query response, at least in similar situations. Thus, in response to determining that the user feedback is not positive, method 300 advances from operation 312 to operation 314. There, operation 314 includes decreasing a score assigned to the models and/or combinations of models that produced the output selected in operation 308.

However, in response to determining that the user feedback is positive, method 300 advances from operation 312 to operation 316. There, operation 316 includes increasing a score assigned to the models and/or combinations of models that produced the output selected in operation 308. Again, this reinforcement learning allows the adaptive reasoner and the multi-model aggregator as a whole to gain contextual information over time and provide more reliable responses to user queries. It follows that the operations of method 300 may be repeated in an iterative fashion in response to receiving user queries over time.

It follows that method 300 is desirably able to capture and classify variations of prompt injections to maintain confidential data and avoid any abuse. Approaches are also able to recommend a number of potential models and/or combinations of models to improve the results in similar context. Approaches can provide recommendations on a series of AI workloads for each use case in order to enhance applicability of enterprise operations. Approaches herein are also able to tailor multiple AI workloads for a use case with predefined configurations, and evaluate the given process tree with historical data. Some approaches further align and map the semantics of the responses without deviating from the context of the original user query. Moreover, approaches herein are desirably able to overcome the burden of traditional reporting and move to state-of-the-art data driven story telling with facts and contextual insights, e.g., as would be appreciated by one skilled in the art after reading the present description.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM), comprising:
receiving, at a context-aware multi-model aggregator, a user query from an endpoint device;
evaluating the user query;
selecting models and/or combinations of models to evaluate the user query based at least in part on the evaluation of the user query;
selecting, by an adaptive reasoner of the context-aware multi-model aggregator, an output to the user query based at least in part on results of the selected models and/or combinations of models;
transmitting the output to the endpoint device; and
performing reinforcement learning based at least in part on feedback received from the endpoint device.

2. The CIM of claim 1, wherein the user query is evaluated using a context analyzer of the context-aware multi-model aggregator.

3. The CIM of claim 2, wherein the selecting of the models and/or combinations of models to evaluate the user query includes:
submitting contextual information extracted from the user query by the context analyzer, to a service mapper of the context-aware multi-model aggregator;
receiving a number of suggested models and/or combinations of models that may be used to evaluate the user query; and
selecting a subset of the suggested models and/or combinations of models to evaluate the user query.

4. The CIM of claim 1, wherein the selected models and/or combinations of models include publicly available models and private models.

5. The CIM of claim 1, wherein the selected models and/or combinations of models include only private models.

6. The CIM of claim 1, wherein the selecting of the output to the user query includes:
causing the adaptive reasoner to filter the selected models and/or combinations of models based on one or more predetermined data and/or privacy standards.

7. The CIM of claim 1, wherein the selected models and/or combinations of models include artificial intelligence (AI) based models selected from the group consisting of: machine learning models, generative AI models, deep learning models, natural language processing models, large language models, and foundation models.

8. The CIM of claim 7, wherein the selected models and/or combinations of models include generative AI models and large language models.

9. The CIM of claim 1, wherein the performing of the reinforcement learning includes:
in response to receiving positive feedback from the endpoint device, increasing a score assigned to the models and/or combinations of models that produced the transmitted output; and
in response to receiving negative feedback from the endpoint device, decreasing a score assigned to the models and/or combinations of models that produced the transmitted output.

10. The CIM of claim 1, wherein the context-aware multi-model aggregator is located at a central server, wherein the endpoint device and the central server are both connected to a network.

11. A computer program product (CPP), comprising:
a set of one or more computer-readable storage media; and
program instructions, collectively stored in the set of one or more storage media, for causing a processor set to perform the following computer operations:
receive, at a context-aware multi-model aggregator, a user query from an endpoint device;
evaluate the user query;
select models and/or combinations of models to evaluate the user query based at least in part on the evaluation of the user query;
select, by an adaptive reasoner of the context-aware multi-model aggregator, an output to the user query based at least in part on results of the selected models and/or combinations of models;
transmit the output to the endpoint device; and
perform reinforcement learning based at least in part on feedback received from the endpoint device.

12. The CPP of claim 11, wherein the user query is evaluated using a context analyzer of the context-aware multi-model aggregator, wherein the selecting of the models and/or combinations of models to evaluate the user query includes:
submitting contextual information extracted from the user query by the context analyzer, to a service mapper of the context-aware multi-model aggregator;
receiving a number of suggested models and/or combinations of models that may be used to evaluate the user query; and
selecting a subset of the suggested models and/or combinations of models to evaluate the user query.

13. The CPP of claim 11, wherein the selected models and/or combinations of models include publicly available models and private models.

14. The CPP of claim 11, wherein the selected models and/or combinations of models include only private models.

15. The CPP of claim 11, wherein the selecting of the output to the user query includes:
causing the adaptive reasoner to filter the selected models and/or combinations of models based on one or more predetermined data and/or privacy standards.

16. The CPP of claim 11, wherein the selected models and/or combinations of models include artificial intelligence (AI) based models selected from the group consisting of: machine learning models, generative AI models, deep learning models, natural language processing models, large language models, and foundation models.

17. A computer system (CS), comprising:
a processor set;
a set of one or more computer-readable storage media;
program instructions, collectively stored in the set of one or more storage media, for causing the processor set to perform the following computer operations:
receive, at a context-aware multi-model aggregator, a user query from an endpoint device;
evaluate the user query;
select models and/or combinations of models to evaluate the user query based at least in part on the evaluation of the user query;
select, by an adaptive reasoner of the context-aware multi-model aggregator, an output to the user query based at least in part on results of the selected models and/or combinations of models;
transmit the output to the endpoint device; and
perform reinforcement learning based at least in part on feedback received from the endpoint device.

18. The CS of claim 17, wherein the user query is evaluated using a context analyzer of the context-aware multi-model aggregator, wherein the selecting of the models and/or combinations of models to evaluate the user query includes:
submitting contextual information extracted from the user query by the context analyzer, to a service mapper of the context-aware multi-model aggregator;
receiving a number of suggested models and/or combinations of models that may be used to evaluate the user query; and
selecting a subset of the suggested models and/or combinations of models to evaluate the user query.

19. The CS of claim 17, wherein the selected models and/or combinations of models include publicly available models and private models.

20. The CS of claim 17, wherein the selecting of the output to the user query includes:
causing the adaptive reasoner to filter the selected models and/or combinations of models based on one or more predetermined data and/or privacy standards.
